(19) United States
(12) Patent Application Publication
(10) Pub. No.: US 2020/0073903 A1
(43) Pub. Date: Mar. 5, 2020

(54) METHOD AND DEVICE OF TAGGING LINKS INCLUDED IN A SCREENSHOT OF WEBPAGE

(71) Applicant: Samsung Electronics Co., Ltd., Suwon-si, Gyeonggi-do (KR)

(72) Inventors: Arihant JAIN, Noida (IN); Himanshu GUPTA, Noida (IN)

(21) Appl. No.: 15/751,011

(22) PCT Filed: Sep. 1, 2016
(86) PCT No.: PCT/KR2016/009753

§ 371 Date: Feb. 7, 2018

(30) Foreign Application Priority Data
Sep. 2, 2015 (IN) 2761/DEL/2015

(51) Int. Cl. G06F 16/955; G06K 9/00; G06K 9/20; G06F 17/21

(52) U.S. Cl. CPC G06F 16/9558; G06F 17/218; G06K 9/2072; G06K 9/00456

(57) ABSTRACT

The present disclosure relates to methods and systems of tagging a screenshot. In accordance with one example embodiment of the disclosure, one or more links present in a first webpage and a corresponding location of the one or more links in the first webpage are identified. The first webpage being rendered on a first browser window on a electronic device. Upon identifying, the one or more links are tagged at a relative position on a screenshot of the first webpage corresponding to the identified location, such that accessing a tagged link on the screenshot renders a second webpage associated with the tagged link in a second browser window.

### TECHNICAL FIELD

The present disclosure generally relates to methods and system for generating and browsing smart screenshots.

### BACKGROUND ART

One of the easiest and most commonly used features for storing information is taking or capturing a screenshot of a user's screen. Taking a screenshot allows a user to save information without the need for a copy/paste operation. Current techniques are available as additional applications and extensions for different browsers that enable capturing a screenshot of different regions on the user's screen when viewing a webpage. Additionally, these techniques allow the user to perform quick edits, add text annotations, and mask certain information of the screenshot; save the screenshot in different formats; and share the saved screenshots through various applications such as email, chat applications, and shared drives.

Further, with the increase in feature rich mobile phone applications for smartphones, present smartphones also include a screenshot capturing feature. With such a feature, the user can capture a screenshot of a webpage or a page of a mobile-based application. The user can initiate a screen capture of an entire screen of the smartphone or a designated area on the screen by either a combination of hardware buttons on the smartphone or selecting the feature itself and may save the captured screenshot to the memory of the smartphone. Some techniques also allow the user to continuously capture screenshots of content displayed on the screen of the smartphone and stitch the captured multiple screenshots together to form a dynamic video.

However, such screenshots are static in nature, both in individual or dynamic video format. In other words, links present in the webpage or the mobile-based application are saved in the screenshot as an image or part of an image, and therefore the user is unable to access the links directly from the captured screenshot. Consequently, the user has to perform manual steps of typing the links in a browser or searching for the link in the mobile-based application to access the link present in the screenshot.

Further, currently some techniques provide image-tagging features or functions. In one technique, a feature automatically detects faces in an image on the smartphone display and suggests contacts from a contact list or address book to tag in the image. However, the feature does not share the tagged data when the user shares the image via various applications on the smartphone.

In another technique, a feature allows users to tag images uploaded on a social network site with profile links to profiles of contacts or themselves. Upon clicking the tagged data, a browser opens the tagged profile on the social network site. However, upon taking a screenshot of the webpage containing the tagged image on the social network site, a profile link tagged to the image becomes part of the static screenshot and clicking on the profile link does not open the corresponding profile on the social network site.

In one another technique, a feature allows tagging of images by a user on a webpage. In yet another technique, a feature allows a user participating in online group discussion sessions such as video chat sessions to capture an image, such as a screenshot of the video chat session including the participants, tag the participants in the image, and share the image. However, these techniques only allow tagging of faces within the images. These techniques do not detect the presence of links in the images and tag the links on the image. In addition, capturing a screenshot of the tagged images still provides a static image, which is not capable of providing access to the links.

Further, in yet one another technique, a feature allows the user to capture a screenshot of a current scene in a video game. Upon capturing the screenshot, the feature detects locations of objects on the scene and assigns tags to the objects included in the captured screenshot. The objects may be building, avatars, trees, animals, clouds, storm, and the like, and the tags provide information corresponding to the objects such as building height, movements of animals, and the presence of clouds or storms. However, the tags on the screenshot do not provide access to the video game.

Furthermore, currently some techniques allow creation of automatic screenshot from links. In one such technique, upon inserting a link in a computer application, e.g., a notebook PC application, the application accesses the link, creates a screenshot of content accessible via the link, and provides an option to the user to insert the screenshot into the application. Upon inserting the screenshot, the user or the application can tag the screenshot. The tags include data related to the content based on the context, images, topics, or other related topics. However, such a screenshot is still a static image that does not include any link present in the content or include tags providing access to the links.

Yet some other techniques allow tagging of a website based on tagging information provided by previous visitors to the website. However, a screenshot of such a website still does not include the tags added to the website. Further, in all of the above-mentioned techniques, the user has to perform manual steps of typing the links in a browser or searching for the link in the mobile-based application to access the link present in the screenshot.

Thus, there exists a need for a solution to overcome above-mentioned deficiencies.

### DISCLOSURE OF INVENTION

### Solution to Problem

In accordance with the purposes of the disclosure, the present disclosure as embodied and broadly described herein, provides a methods and devices for tagging links included in a screenshot and correspondingly rendering the links from the screenshot.

### Advantageous Effects of Invention

Method for tagging links included in a screenshot and rendering the links from the screenshot is provided.

### BRIEF DESCRIPTION OF DRAWINGS

To further clarify advantages and aspects of the disclosure, a more particular description of the disclosure will be rendered by reference to specific example embodiments thereof, which is illustrated in the appended drawings. It is appreciated that these drawings depict only typical example embodiments of the disclosure and are therefore not to be considered limiting of its scope. The disclosure will be described and explained with additional specificity and detail with the accompanying drawings, which are listed below for quick reference.

FIGS. 1A-1C are flow charts illustrating a method of tagging links included in a screenshot of a webpage, in accordance with an example embodiment of the present disclosure.

FIGS. 2A-2F are flow charts illustrating a method of rendering tagged links included in a screenshot of a webpage, as illustrated in FIG. 1A-1C, in accordance with an example embodiment of the present disclosure.

FIGS. 3A-3B are flow charts illustrating a method of tagging links included in a screenshot of an application, in accordance with an example embodiment of the present disclosure.

FIGS. 4A-4C are flow charts illustrating a method of rendering tagged links included in a screenshot of an application, as illustrated in FIG. 3, in accordance with an example embodiment of the present disclosure.

FIG. 5 illustrates a block diagram of a system implementing the methods as illustrated in FIGS. 1A-1C through FIGS. 4A-4C in accordance with an example embodiment.

FIGS. 6A and 6G illustrate a process of tagging links included in a screenshot of a webpage, in accordance with an example embodiment of the present disclosure.

FIGS. 7A and 7C illustrate a process of tagging links included in a screenshot of a page of an application, in accordance with an example embodiment of the present disclosure.

FIGS. 8A-8C and 9 illustrate a process of rendering tagged links included in a screenshot, in accordance with various example embodiments of the present disclosure.

FIG. 10A-10C illustrates a process of sharing a screenshot, in accordance with an example embodiment of the present disclosure.

FIG. 11 illustrates an example network environment implementing various example embodiments of disclosure.

FIG. 12 illustrates a typical hardware configuration of a electronic device, which is representative of a hardware environment for practicing the present disclosure.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding the example embodiments of the disclosure so as not to obscure the drawings with details that will be readily apparent to those of ordinary skill in the art having benefit of the description herein.

### BEST MODE FOR CARRYING OUT THE INVENTION

Accordingly, upon receiving a request to capture a screenshot of a webpage or a page of the application being rendered on a electronic device, one or more links present in the webpage or the page are identified. Further, corresponding locations of the one or more links on the webpage or the page are identified. Upon identifying, the one or more links are tagged at a relative position on the screenshot corresponding to the identified location, such that accessing a tagged link on the screenshot renders a second webpage or a second page associated with the tagged link on the electronic device.

In a similar manner, upon receiving a user-input on a screenshot being rendered on a electronic device, a location of the user-input is determined. Upon determining the location, an availability of a link tagged in the screenshot at the location of the user-input is determined. Upon receiving a request to access the link, the tagged link is rendered on the electronic device. Further, prior to receiving the request to access the link, an application corresponding to the tagged link is determined such that the tagged link is rendered in the detected application. One or more exemplary embodiment provide a method of tagging links included in a screenshot of a webpage, the method comprising; identifying one or more links included in a first webpage and a location of the one or more links in the first webpage, the first webpage being rendered on a first browser window on a electronic device; and tagging the one or more links at a position on a screenshot of the first webpage, the position corresponding to the identified location, and wherein accessing a tagged link included in the screenshot includes rendering, via a second browser window, a second webpage associated with the tagged link

Another exemplary embodiment provides a method wherein the identifying and the tagging are based on a request to capture the screenshot of the first webpage, the request being received by the electronic device from a user.

Another exemplary embodiment provides a method, wherein the request to capture the screenshot is received via one of: the first browser window, the electronic device, and a screen capture application installed on the electronic device.

Another exemplary embodiment provide a method, wherein the identifying of the location further comprises: sending a request for the location of the one or more links included in the first webpage as rendered on the first browser window to a browser controlling the first browser window; and receiving the location of the one or more links from the browser.

Another exemplary embodiment provides a method wherein the tagging further comprises: generating metadata indicative of a mapping of the tagged one or more links and the position on the screenshot; and associating the metadata with the screenshot.

Another exemplary embodiment provide a method, wherein the metadata further includes data indicative of geographical information associated with the tagged one or more links and a source of the tagged one or more links, the tagged one or more links including a link corresponding to the first webpage.

Another exemplary embodiment provides a method, wherein the association of the metadata comprises embedding the metadata in the screenshot.

Another exemplary embodiment provides a method, wherein the association of the metadata comprises storing the metadata, distinct from the screenshot, in a separate file.

Another exemplary embodiment provides a method, wherein the association of the metadata is performed by a file viewing application.

Another exemplary embodiment provides a method further comprises: receiving an input selecting an area of the first webpage to be captured in the screenshot of the first webpage, wherein the one or more links are included within the selected area.

Another exemplary embodiment provides a method, wherein the area is selected from a group comprising of: a visible area of the first webpage, a user-selected area of the first webpage, window area of the first webpage in the first browser window, and one or more tabs activated in the first browser window along with the first webpage.

Another exemplary embodiment provides a method further comprising: receiving an input selecting a first set of links from the one or more links, the first set of links being a non-null set, wherein each of the links included in the first set of links is tagged in the screenshot.

Another exemplary embodiment provides a method wherein the selection of the first set of links is one of: an automatic selection, a manual selection, and a combination thereof. Another exemplary embodiment provide a method, wherein the tagging of the one or more links includes tagging information associated with the one or more links, the information comprising: a name of the one or more links, a brief description of the one or more links, a brief description of content corresponding to the one or more links, and geographical information associated with the one or more links.

Another exemplary embodiment provides a method, wherein the information is editable in the screenshot.

Another exemplary embodiment provides a method wherein the link is a uniform resource locator (URL) associated with a webpage element included in the webpage.

Another exemplary embodiment provide a method, wherein the link is a uniform resource locator (URL) associated with a webpage element included in one or more tabs activated in the browser window along with the webpage.

Another exemplary embodiment provides a method comprising: receiving a user-input on a screenshot being rendered on a electronic device; determining a location of the user-input on the screenshot; determining whether a tagged link included in the screenshot is located at the determined location; and rendering a webpage associated with the tagged link in a browser window on the electronic device in response to receiving a request to access the tagged link

Another exemplary embodiment provides a method, further comprising obtaining metadata associated with the screenshot, the metadata including a mapping of one or more tagged links included in the screenshot and a position of the one or more tagged links on the screenshot.

Another exemplary embodiment provides method, wherein the metadata is embedded within the screenshot, and the determination of whether the tagged link included in the screenshot is located at the determined location further comprises: detecting a position of the tagged link, and determining whether the detected position of the tagged link corresponds to the location of the user-input, based on the metadata; and visually indicating the tagged link at the detected position on the screenshot.

Another exemplary embodiment provides method, wherein the metadata is obtained from a file distinct from the screenshot, and the determination of whether the tagged link included in the screenshot is located at the determined location further comprises: detecting the tagged link based on the location of the user-input and the metadata; fetching the tagged link and a corresponding position of the tagged link from the file; and visually indicating the tagged link at the corresponding position on the screenshot.

Another exemplary embodiment provides a method, wherein the rendering of the webpage further comprises: providing a browser list comprising of one or more browsers available on the electronic device in response to receiving the request to access the tagged link; receiving an input selecting a browser from the browser list; and launching a browser window corresponding to the selected browser, the browser window rendering content retrieved from a server and associated with the tagged link

Another exemplary embodiment provides a method, wherein the rendering of the webpage further comprises: identifying a browser to render the webpage based on predefined browser information; and launching a browser window corresponding to the identified browser, the browser window rendering content retrieved from a server and associated with the tagged link

Another exemplary embodiment provides a method, wherein the browser window is launched in a new browser instance of a browser.

Another exemplary embodiment provides a method, wherein the browser window is launched in a new tab in a prior launched browser instance of a browser.

Another exemplary embodiment provides a method, wherein the user-input is one of a touch gesture input, a non-touch gesture input, and an input from an input device communicatively coupled to the electronic device.

Another exemplary embodiment provides a method, further comprising: determining dimensions of the screenshot; and updating the position of the one or more tagged links on the screenshot based on the determined dimensions.

Another exemplary embodiment provides a method, wherein the dimensions of the screenshot are determined based on one or more of: screen size of a display unit of the electronic device, orientation of the screenshot on the display unit, and a user-input corresponding to a resizing action associated with the screenshot.

One or more exemplary embodiment provides a method of tagging links included in a screenshot of an application, the method comprising; identifying one or more links included in a first page of the application and a location of the one or more links in the first page, the first page being rendered via a window on a electronic device; and tagging the one or more links at a position on a screenshot of the first page, the position corresponding to the identified location, wherein accessing a tagged link included in the screenshot includes rendering a second page associated with the tagged link on the electronic device.

Another exemplary embodiment provides a method wherein the identification and the tagging are based on a request to capture the screenshot of the application, the request being received from a user on the electronic device.

Another exemplary embodiment provides a method wherein the identification of the location further comprises: sending a request for the location of the one or more links in the rendered first page to a content rendering module associated with the application; and receiving the location corresponding to the one or more links from the content rendering module.

Another exemplary embodiment provides a method, further comprising sharing the screenshot via one or more applications available on the electronic device, wherein the one or more applications include said application and are adapted to render the screenshot.

Another exemplary embodiment provides a method, wherein the application is installed on the electronic device.

Another exemplary embodiment provides a method, wherein the request is received by a screen capturing module associated with the application.

One or more exemplary embodiment provides a method comprising: receiving a user-input on a screenshot being rendered on a electronic device; determining a location of the user-input on the screenshot; determining whether a tagged link included in the screenshot is located at the determined location; detecting an application corresponding to the tagged link; and rendering the tagged link via the detected application on the electronic device in response to receiving a request to access the tagged link

Another exemplary embodiment provides a method wherein the detecting of the application is based on metadata associated with the screenshot, the metadata including a source of one or more links tagged in the screenshot.

Another exemplary embodiment provides a method, wherein the detected application is one of a browser application and a mobile-based application.

Another exemplary embodiment provides a method, wherein the detecting of the application further comprises: determining whether the detected application is available on the electronic device; and launching the detected application on the electronic device, the detected application rendering content retrieved from a server associated with the tagged link

Another exemplary embodiment provides a method, wherein the detecting of the application further comprises: providing a list comprising of a plurality of applications available on the electronic device, the plurality applications including the detected application; and receiving an input selecting an application from the list; and launching the selected application on the electronic device, the selected application rendering content retrieved from a server associated with the tagged link

Another exemplary embodiment provides a method wherein the selected application is one of a browser application and a mobile-based application.

One or more exemplary embodiment provides an electronic device for tagging links included in a screenshot of a webpage, the electronic device comprising; a display configured to: display a first browser window; a first webpage in the first browser window; and a second browser window; and at least one processor configured to: identify one or more links included in the first webpage; identify a location of the one or more links in the first webpage; and tag the one or more links at a position on a screenshot of the first webpage, the position corresponding to the identified location, wherein accessing a tagged link on the screenshot includes rendering, via the second browser window, a second webpage associated with the tagged link

One or more exemplary embodiment provides an electronic device comprising: a display configured to display a screenshot; at least one processor configured to: receive a user-input on the screenshot; determine a location of the user-input on the screenshot; determine whether a tagged link included in the screenshot is located at the determined location; and render a webpage corresponding to the tagged link in a browser window on the display unit in response to receiving a request to access the tagged link

One or more exemplary embodiment provides an electronic device for tagging links included in a screenshot of an application, the electronic device comprising; a display configured to: display the application in a window; and a first page of the application in the window; at least one processor configured to: identify one or more links included in the page; identify a location of the one or more links in the first page; and tag the one or more links at a position on a screenshot of the first page corresponding to the identified location, wherein accessing a tagged link includes rendering, on the display, a second page associated with the tagged link

One or more exemplary embodiment provide an electronic device for rendering a page of an application, the electronic device comprising: a display configured to display a screenshot; at least one processor configured to receive a user-input on the screenshot; determine a location of the user-input on the screenshot; determine whether a tagged link included in the screenshot is located at the determined location; determine an application corresponding to the tagged link; and render the tagged link via the detected application on the display in response to receiving a request to access the tagged link

These aspects and advantages will be more clearly understood from the following detailed description taken in conjunction with the accompanying drawings and claims.

### MODE FOR THE INVENTION

It should be understood at the outset that although illustrative example embodiments of the example embodiments of the present disclosure are illustrated below, the present disclosure may be implemented using any number of techniques, whether currently known or in existence. The present disclosure should in no way be limited to the illustrative example embodiments, drawings, and techniques illustrated below, including the example design and example embodiment illustrated and described herein, but may be modified within the scope of the appended claims along with their full scope of equivalents.

The term “some” as used herein is defined as “none, one, more than one, or all.” Accordingly, the terms “none,” “one,” “more than one,” “more than one, but not all” or “all” would all fall under the definition of “some.” The term “some example embodiments” may refer to one example embodiment, to several example embodiments, or to all example embodiments, or may refer to an example embodiment not described herein. Accordingly, the term “some example embodiments” is defined as meaning “one example embodiment, more than one example embodiment, or all example embodiments, or an example embodiment not described herein.”

The terminology and structure employed herein is for describing, teaching and illuminating some example embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features”, “one or more elements”, “at least one feature”, or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “example embodiments.” It should be understood that an example embodiment is an example of a possible example embodiment of any features and/or elements presented in the attached claims. Some example embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first example embodiment,” “a further example embodiment,” “an alternate example embodiment,” “one example embodiment,” “an example embodiment,” “multiple example embodiments,” “some example embodiments,” “other example embodiments,” “further example embodiment”, “furthermore example embodiment”, “additional example embodiment” or variants thereof do NOT necessarily refer to the same example embodiments. Unless otherwise specified, one or more particular features and/or elements described in connection with one or more example embodiments may be found in one example embodiment, more than one example embodiment, or all example embodiments, or may be omitted from one or more of the example embodiments. Although one or more features and/or elements may be described herein in the context of only a single example embodiment, or alternatively in the context of more than one example embodiment, or further alternatively in the context of all example embodiments, the features and/or elements may instead be provided separately or in any appropriate combination or not at all. Conversely, any features and/or elements described in the context of separate example embodiments may alternatively be realized as existing together in the context of a single example embodiment.

Any particular and all details set forth herein are used in the context of some example embodiments and therefore should NOT be necessarily taken as limiting factors to the attached claims. The attached claims and their legal equivalents can be realized in the context of example embodiments other than the ones used as illustrative examples in the description below.

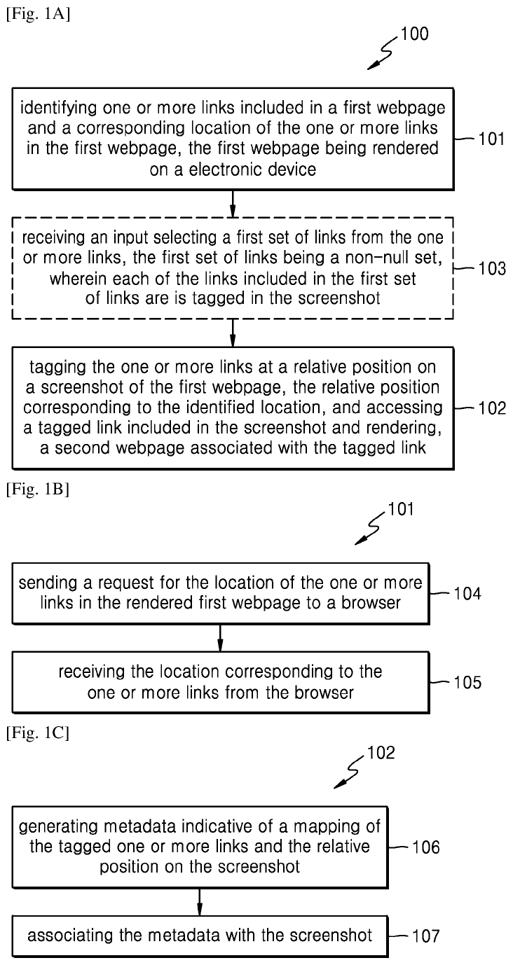

Referring to FIG. 1A, there is illustrated an example method (100) of tagging links included in a screenshot of a webpage in accordance with an example embodiment of present disclosure. In said example embodiment, the method (100) comprises the steps of: identifying (101) one or more links included in a first webpage and a corresponding location of the one or more links in the first webpage, the first webpage being rendered on a electronic device; and tagging (102) the one or more links at a relative position on a screenshot of the first webpage, the relative position corresponding to the identified location, and accessing a tagged link included in the screenshot and rendering a second webpage associated with the tagged link in a second browser window. In an example embodiment, the first webpage may be rendered on a first browser window and the second webpage may be rendered on a second browser window.

By way of non-limiting example, the link may be a uniform resource locator (URL) associated with a webpage element in the rendered webpage. By way of yet another non-limiting example, the link may be a uniform resource locator (URL) associated with a webpage element in one or more tabs activated in the browser window along with the rendered webpage.

Further, the steps of the identification (101) and the tagging (102) may be based on a screenshot request to capture a screenshot of the first webpage, and the electronic device may receive the request from a userelectronic. The request to capture the screenshot may be received via one of: the first browser window, the electronic device, and a screen capture application installed on the electronic device. In addition, an input selecting an area of the rendered first webpage to be captured in the screenshot is received, and one or more links may be identified within the selected area. The area may be selected from a group including of: visible area of the rendered first webpage, a user-selected area of the rendered first webpage, a window area of the rendered first webpage in the first browser window, and one or more tabs activated in the first browser window along with the rendered first webpage.

Further, the method (100) may include the step of receiving (103) an input selecting a first set of links from the one or more links, the first set of links being a non-null set, wherein each of the links included in the first set of links are is tagged in the screenshot. The first set of links may be selected automatically, manually, or by a combination thereof.

Referring to FIG. 1B, the step of identification (101) of the location may further include the steps of sending (104) a request for the location of the one or more links in the rendered first webpage to a browser controlling the first browser window and receiving (105) the location corresponding to the one or more links from the browser.

Referring to FIG. 1C, the step of tagging (101) of the location may further include the steps of generating (106) metadata indicative of a mapping of the tagged one or more links and the relative position on the screenshot and associating (107) the metadata with the screenshot. The metadata may further include data indicative of geographical information associated with the one or more links and a source of the one or more links, and the one or more links may include a link corresponding to the first webpage.

Further, in one aspect of the present disclosure, the step of association (107) of the metadata may include embedding the metadata in the screenshot. In another aspect of the present disclosure, the step of association (107) of the metadata may include storing the metadata, distinct from the screenshot, in a separate file.

Further, in yet another aspect of the present disclosure, the step of association (107) of the metadata may be performed by a file viewing application, for example, an image viewing application or a screenshot viewing application.

Further, the step of tagging (102) may include tagging information associated with the link, the information including a name of the link, a brief description of the link, a brief description of content corresponding to the link, and geographical information associated with the link In addition, the information in the screenshot is editable.

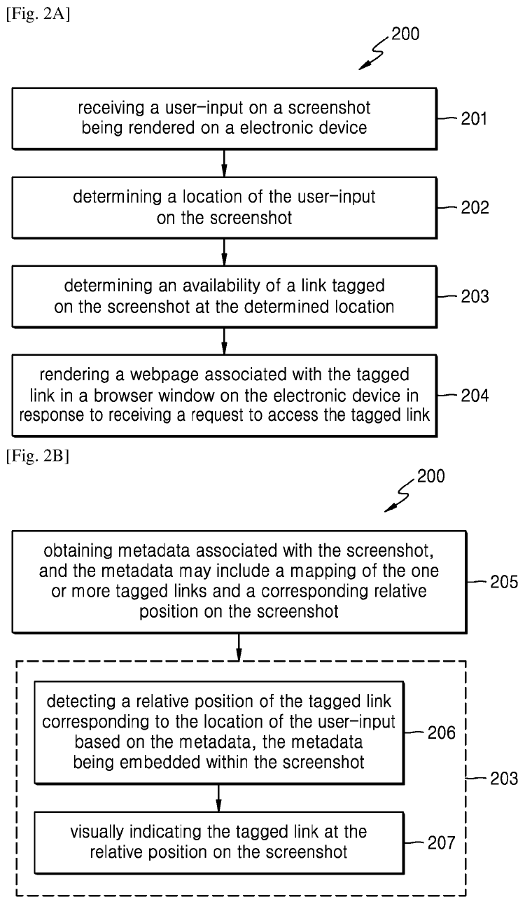

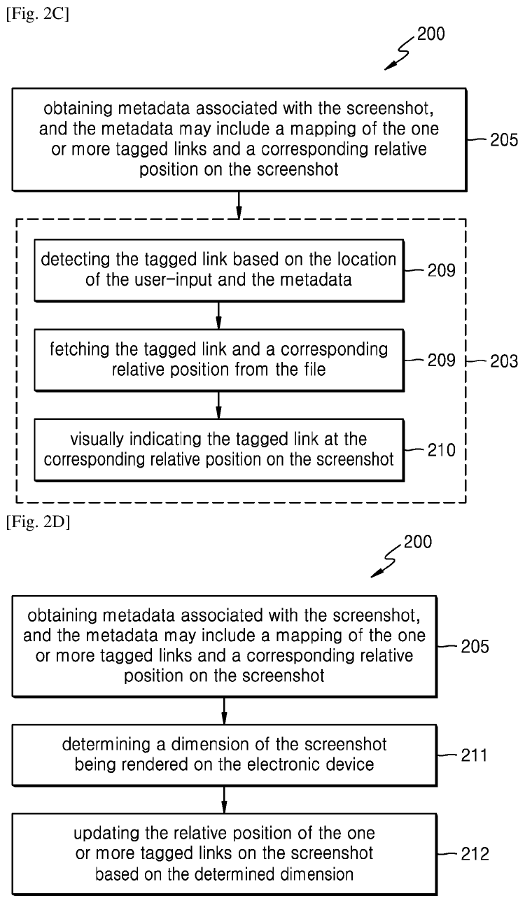

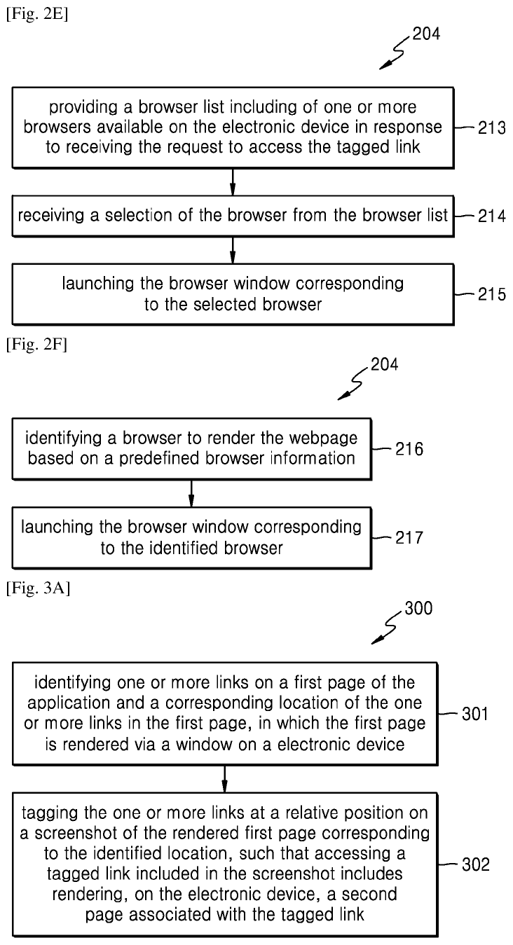

Referring to FIG. 2A, there is illustrated a flow chart of a method (200) for rendering tagged links included in a screenshot of a webpage, as illustrated in FIGS. 1a-1c, in accordance with an example embodiment of the present disclosure. In said example embodiment, the method (200) may include the steps of: receiving (201) a user-input on a screenshot being rendered on a electronic device; determining a location (202) of the user-input on the screenshot; determining an availability (203) of a link tagged on the screenshot at the determined location (e.g., determining whether a tagged link included in the screenshot is located at the determined location); and rendering (204) a webpage associated with the tagged link in a browser window on the electronic device in response to receiving a request to access the tagged link

By way of non-limiting example, the browser window may be launched in a new browser instance of a browser (e.g., a new browser window). By way of another non-limiting example, the browser window may be launched in a new tab of a prior launched browser instance of a browser. By way of one another non-limiting example, the user-input may be one of a touch gesture input, a non-touch gesture input, and an input from an input device communicatively coupled to the electronic device.

Further, referring to FIGS. 2B, and 2C, the method (200) may include the step of obtaining (205) metadata associated with the screenshot, and the metadata may include a mapping of the one or more tagged links and a corresponding relative position on the screenshot. As illustrated in FIG. 1c, the metadata may be embedded within the screenshot or the metadata may be stored distinct from the screenshot in a separate file. Thus, the step of determining the availability (203) of the first link may be based on the association of the metadata. Therefore, in one aspect of the present disclosure, referring to FIG. 2B, the step of determining the availability (203) of the first link further may include the steps of: detecting (206) a relative position of the tagged link corresponding to the location of the user-input based on the metadata, the metadata being embedded within the screenshot; and visually (207) indicating the tagged link at the relative position on the screenshot.

In another aspect of the present disclosure, referring to FIG. 2C, the step of determining the availability (203) of the first link further may include the steps of: detecting (208) the tagged link based on the location of the user-input and the metadata; fetching (209) the tagged link and a corresponding relative position from the file; and visually (210) indicating the tagged link at the corresponding relative position on the screenshot. The metadata may be obtained from a file distinct from the screenshot.

Further, in one aspect of the present disclosure, the method as illustrated in FIGS. 2B and 2 C may include further steps as illustrated in FIG. 2D. Specifically, upon obtaining the metadata in step 205, the method (200) may further include the steps of: determining a dimension (211) of the screenshot being rendered on the electronic device; and updating (212) the relative position of the one or more tagged links on the screenshot based on the determined dimension. By way of non-limiting examples, the dimension of the screenshot may be determined based on one or more of: screen size of a display unit of the electronic device, orientation of the screenshot on the display unit, and a user-input corresponding to a resizing action associated with the screenshot.

Further, the webpage associated with the tagged link may be rendered based on either a user-input or predefined information. Thus, in one aspect of the present disclosure, referring to FIG. 2E, the step of rendering (204) of webpage may further include the steps of: providing (213) a browser list including of one or more browsers available on the electronic device in response to receiving the request to access the tagged link; receiving (214) a selection of the browser from the browser list; and launching (215) the browser window corresponding to the selected browser. The browser window may render content retrieved from a server associated with the tagged link

In another aspect of the present disclosure, referring to FIG. 2F, the step of rendering (204) of webpage may further include the steps of: identifying (216) a browser to render the webpage based on a predefined browser information; and launching (217) the browser window corresponding to the identified browser. The browser window may render content retrieved from a server associated with the tagged link

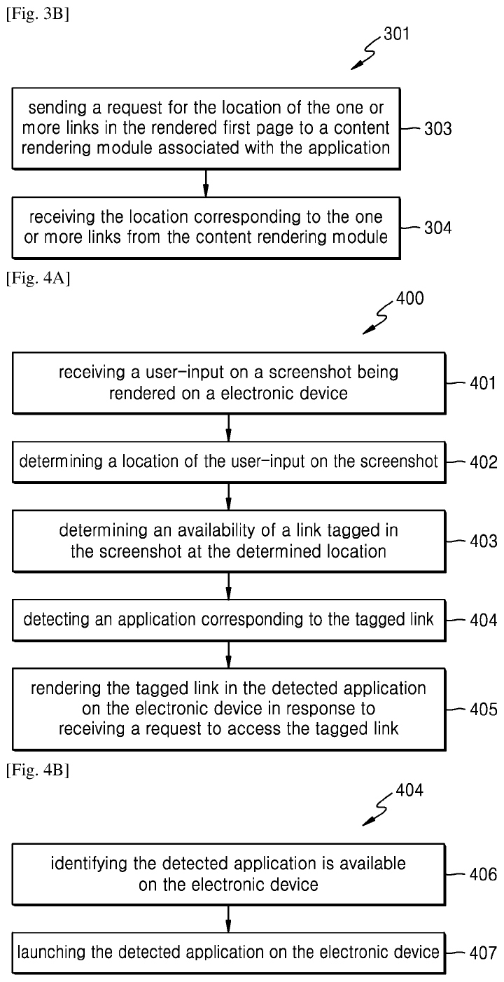

Referring to FIG. 3A, there is illustrated an example method (300) of tagging links included in a screenshot of an application in accordance with an example embodiment of present disclosure. In said example embodiment, the method (300) may include the steps of: identifying (301) one or more links on a first page of the application and a corresponding location of the one or more links in the first page, in which the first page is rendered via a window on a electronic device; and tagging (302) the one or more links at a relative position on a screenshot of the rendered first page corresponding to the identified location, such that accessing a tagged link included in the screenshot includes rendering, on the electronic device, a second page associated with the tagged link

Further, the application may be an application installed on the electronic device. In one example, the application may be a mobile-based application installed on a smartphone. In another example, the application may be an application installed on a smart or Internet Protocol television (IPTV). In one another example, the application may be an application installed on wearable devices such as smart watches. Furthermore, the screenshot may be shared via one or more applications available on the electronic device, and the one or more applications may include said application, and the one or more applications are adapted to render the screenshot.

Further, the steps of identification (301) and tagging (302) may be based on a request to capture the screenshot of the application, and the request may be received from a user on the electronic device. The request may be received by a screen capturing module associated with the application.

Referring to FIG. 3B, the step of identification (301) of the location may further include the steps of sending (303) a request for the location of the one or more links in the rendered first page to a content rendering module associated with the application; and receiving (304) the location corresponding to the one or more links from the content rendering module.

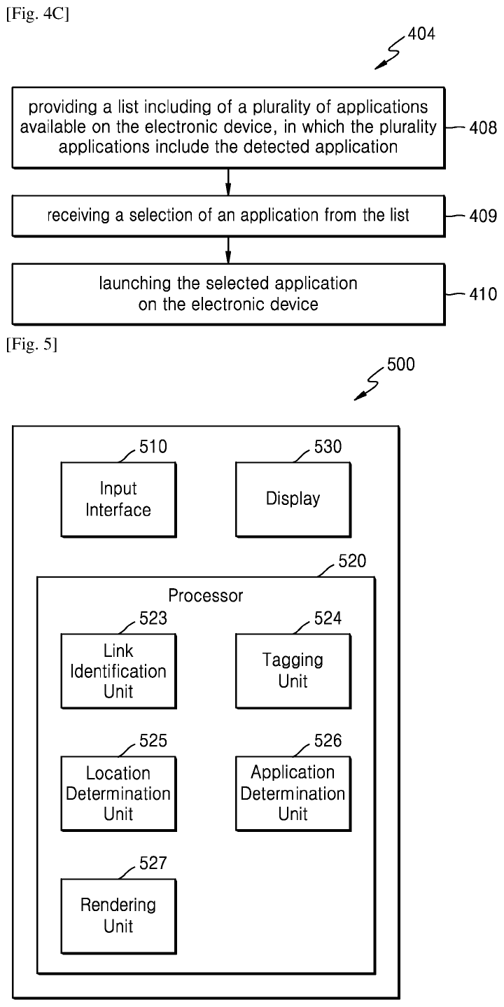

Referring to FIG. 4A, there is illustrated a flow chart of a method (400) for rendering tagged links included in a screenshot of an application, as illustrated in FIG. 3A and 3 B, in accordance with an example embodiment of the present disclosure. In said example embodiment, the method (400) may include the steps of: receiving (401) a user-input on a screenshot being rendered on a electronic device; determining a location (402) of the user-input on the screenshot; determining an availability (403) of a link tagged in the screenshot at the determined location; detecting (404) an application corresponding to the tagged link; and rendering (405) the tagged link in the detected application on the electronic device in response to receiving a request to access the tagged link

Further, the step of detecting (404) the application may be based on metadata associated with the screenshot. The metadata may include a source of one or more links tagged in the screenshot. Furthermore, the detected application may be one of a browser application and an application corresponding to the tagged link The application may be an application installed on the electronic device.

Referring to FIG. 4B, upon detecting the application, the step of detecting (404) the application may further include the steps of: identifying (406) the detected application is available on the electronic device; and launching (407) the detected application on the electronic device. The detected application may render content retrieved from a server associated with the tagged link.

Referring to FIG. 4C, upon detecting the application, the step of detecting (404) the application may further include the steps of: providing (408) a list including of a plurality of applications available on the electronic device, in which the plurality applications include the detected application; receiving (409) a selection of an application from the list; and launching (410) the selected application on the electronic device. The selected application may render content retrieved from a server associated with the tagged link.

As illustrated in FIG. 5, the present disclosure further provides an electronic device (500) implementing the aforesaid methods as illustrated in FIGS. 1a-1c through FIGS. 4a-4c in accordance with an example embodiment. The electronic device (500) may include a user interface (510), a display (530), a processor (520). In an example embodiment, the processor(520) may include a link identification unit(523), a tagging unit (524), a location determination unit (525), an application determination unit (526), and a rendering unit (527). In an example embodiment, the processes performed by the processor(520) may be performed by at least one processor. In an example, the processes performed by a link identification unit(523), a tagging unit (524), a location determination unit (525), an application determination unit (526), and a rendering unit (527) may be performed by at least one processor.

In one aspect of the disclosure, the display (530) may be adapted to render a first webpage. The processor(520), e.g. the link identification unit (523) may be adapted to identify one or more links present in the rendered first webpage and identify a location of the one or more links in the rendered first webpage. The processor(520), e.g. the tagging unit (524) may be adapted to tag the one or more links at a relative position on a screenshot of the rendered first webpage corresponding to the identified location, such that accessing a tagged link on the screenshot renders a second webpage associated with the tagged link on the display (530). In an example embodiment, the display may be adapted to render a first browser window and render a first webpage in the first browser window and the processor may render a second webpage in a second browser window.

In another aspect of the disclosure, the display (530) may be adapted to render the application in a window and render a first page of the application in the window. The processor(520), e.g. the link identification unit (523) may be adapted to identify one or more links present in the page and identify a location of the one or more links in the rendered first page. The tagging unit (524) may be adapted to tag the one or more links at a relative position on a screenshot of the rendered first page corresponding to the identified location, such that accessing a tagged link renders a second page associated with the tagged link on the display (530).

In one another aspect of the disclosure, the display (530) may be adapted to render a screenshot. The input interface (510) may be adapted to receive a user-input on the rendered screenshot. The processor (520), e.g. the location determination unit (525) may be adapted to determine a location of the user-input on the screenshot. The processor (520), e.g. the link identification unit (523) may be further adapted to determine an availability of a link tagged in the screenshot at the determined location. The processor(520), e.g. the rendering unit (527) may be adapted to render a webpage corresponding to the tagged link in a browser window on the display (530) in response to receiving a request to access the tagged link

In yet another aspect of the disclosure, the display (530) may be adapted to render a screenshot. The input interface (510) may be adapted to receive a user-input on the rendered screenshot. The processor (520), e.g. the location determination unit (525) may be adapted to determine a location of the user-input on the screenshot. The processor (520), e.g. the link identification unit (523) may be further adapted to determine an availability of a link tagged in the screenshot at the determined location. The processor (520), e.g. the application determination unit (526) may be adapted to determine an application corresponding to the tagged link The processor (520), e.g. the rendering unit (527) may be adapted to render the tagged link in the detected application on the display unit in response to receiving a request to access the tagged link

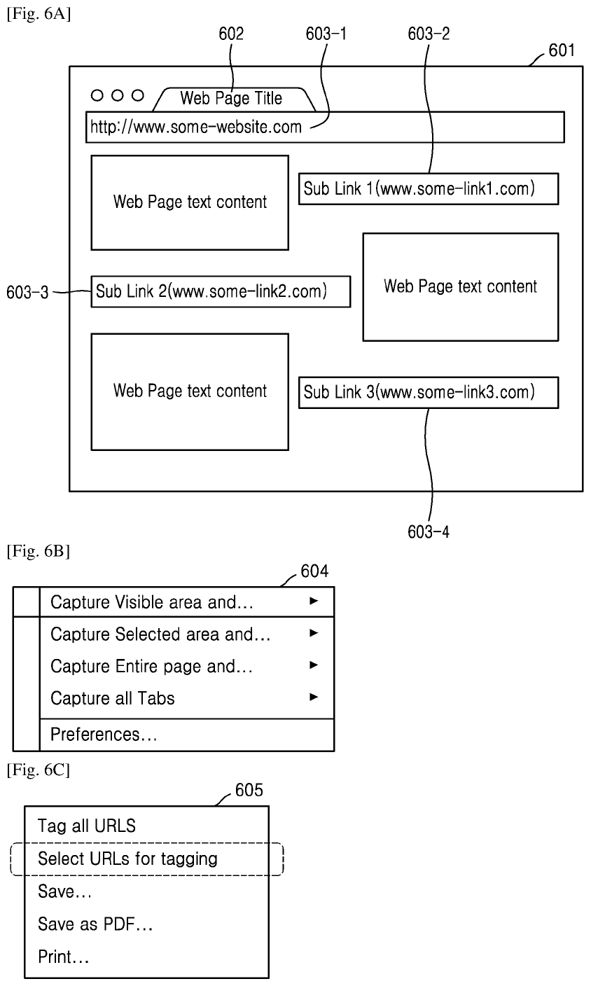

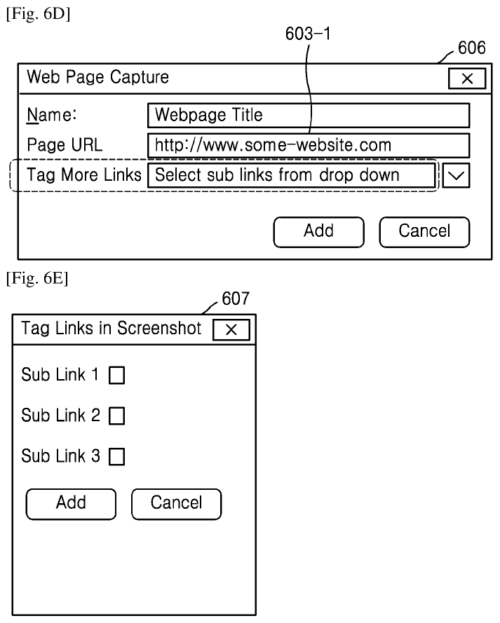

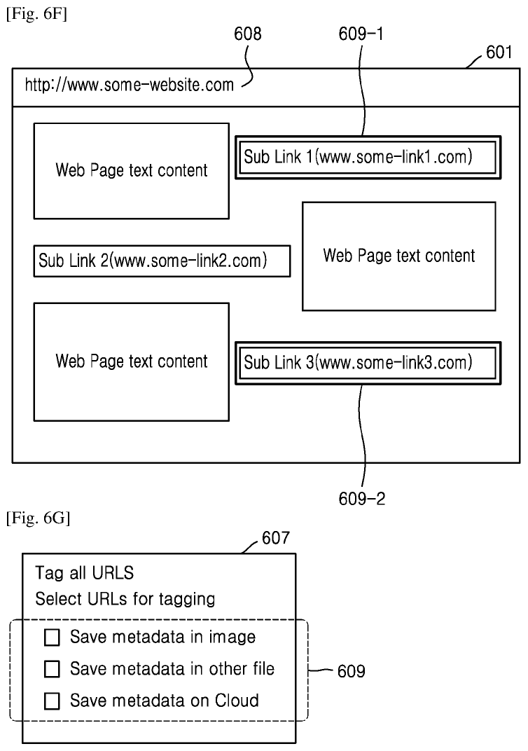

For the ease of understanding, the forthcoming descriptions of FIGS. 6-11 illustrate the example manifestations depicting the example embodiment of various aspects of the present disclosure by the electronic device (500). However, it may be strictly understood that the forthcoming examples are not to be construed as being limitations of the present disclosure, and the present disclosure may be extended to cover analogous manifestations through other type of like mechanisms.

Referring to FIGS. 6A-6G, a process of tagging links in a webpage with a screenshot of the webpage is illustrated.

Accordingly, FIG. 6A illustrates an example electronic device 601 displaying a webpage 602 on a browser window of a browser. Examples of such a electronic device 601 include a desktop, a notebook PC, a tablet, a smart phone, a personal digital assistant (PDA), a smart or Internet Protocol television (IPTV), a wearable device, and a laptop. The browser may be a web browser accessible, for example, on a desktop, a notebook PC, a tablet, and a laptop; or a mobile browser accessible, for example, on a mobile device such as a smart phone or PDA. The webpage 602 may include various webpage elements such as videos, text, static images, animated images, hyperlinks or navigational elements to other portions of a webpage, and data files linked through hyperlinks. The webpage 602 may further include one or more links. The links may be uniform resource locators (URLs) pointing to other webpages. In addition, the videos and images on the webpage 602 may further be associated with links such that clicking on the videos and the images, renders a new webpage associated with the links. For the ease of understanding, the webpage 602 includes plurality of links 603-1, 603-2, 603-3, and 603-4. Link 603-1 corresponds to the webpage 602 and links 603-2, 603-3, and 603-4 correspond to other webpages.

In accordance with an example embodiment of the present disclosure, a feature of tagging the plurality of links 603-1, 603-2, 603-3, and 603-4 on a screenshot of the webpage 602 is provided. The feature may be provided in multiple ways such as, for example, an add-on feature of the browser, a specific feature provided by a screen capture application installed on the electronic device, and an integrated feature of an operating system of the electronic device.

A user may input a request to capture a screenshot of the webpage 602. The user may input the request by one or more methods such as, for example;

pressing a key/button on a keyboard coupled to the electronic device, e.g., pressing a ‘Print Screen’ key;

pressing a combination of keys/buttons on the electronic device, e.g., pressing ‘Volume Down’ and ‘Power’ buttons on the smart phone at the same time;

touching a screenshot icon available on the electronic device, e.g., touching an icon for capturing a screenshot; and

clicking on screenshot add-ons installed on the browser such as, for example, a screenshot option accessible by right clicking on the webpage 602, a screenshot option in a menu bar of the webpage 602, a screenshot button in the toolbar of the browser, and a combination of keys for capturing screenshot.

Accordingly, the input interface (510) may receive the request to capture the screenshot of the webpage 602 from the user. Based on the request, the processor(520), e.g. the link identification unit (523) may identify whether any links are included in the webpage 602. If the link identification unit (523) identifies that no links are included in the webpage 602, the link identification unit (523) enables capturing of a screenshot of the webpage 602 in a conventional manner as known in the art. On the contrary, if the link identification unit (523) identifies that links are included in the webpage 602, the link identification unit (523) may provide a notification to the user indicating links are included in the webpage 602 and an option of tagging the links in a screenshot of the webpage 602. In an example embodiment, if the link identification unit (523) identifies that links are included in the webpage 602, the link identification unit (523) may tag the links in a screenshot of the webpage 602.

As illustrated in FIG. 6B, upon receiving the request, the link identification unit (523) may provide a first option menu 604 on the webpage 602 to the user. The first option menu 604 enables the user to select an area of the webpage 602 to be captured in the screenshot. The areas selectable via the first option menu 604 may include a visible area of the webpage 602, a user-selected area of the webpage 602, a window area of the webpage 602 in the browser window, and a plurality of tabs activated in the browser window along with the webpage 602. In an example, a user-interface providing the first option menu 604 may be displayed on the webpage 602, and the user may select the area via the user-interface.

As illustrated in FIG. 6C, upon receiving a selection of the area via the first option menu 604, the processor(520), e.g. the link identification unit (523) may identify links which are included in the selected area and are available to be tagged, when capturing the screenshot. Subsequently, the link identification unit (523) may provide second option menu 605 on the webpage enabling the user to select the links included in the area. As such, the second option menu 605 enables the user to either select all of the links available in selected are of the webpage 602 or select one or more links included in selected area of the webpage 602. In an example, a user-interface providing the second option menu 605 may be overlaid on the webpage 602, and the user may select the links via the user-interface.

As illustrated in FIG. 6D, upon receiving an input via the second option menu 605 to select one or more links included in the webpage 602 (i.e., ‘Select URLS for tagging’), the processor(520), e.g. the link identification unit (523) may display menu 606 providing information about the webpage 602 and an option to select one or more links included in the webpage 602. In one example, the menu 606 may display a name of the webpage 602 and link 603-1 corresponding to the webpage 602. In one example, the menu 606 may display a menu for selecting sub links as shown in FIG. 6D. Additionally, in one example, a user-interface providing the menu 606 may be overlaid on the webpage 602.

As illustrated in FIG. 6E, upon receiving an input via the menu 606 to select one or more links included in the webpage 602 (i.e., ‘Select sub links from drop down’), the processor(520), e.g. the link identification unit (523) may display a sub-menu 607 listing the plurality of links 603-2 (Sub Link 1), 603-3 (Sub-Link 2), and 603-4 (Sub-Link 3) and an option to select one or more links from the plurality of links 603-2, 603-3, and 603-4. In one example, the identification unit (523) may exclude the link 603-1 corresponding to the webpage 602 from selectable links in the sub-menu 607 such that the link 603-1 is always tagged. In another example, the identification unit (523) may include the link 603-1 corresponding to the webpage 602 among selectable links in the sub-menu 607 such that the link 603-1 is tagged upon selection. Additionally, in one example, a user-interface providing the sub-menu 607 may be overlaid on the webpage 602.

Upon receiving the selection of links in the webpage 602, the processor(520), e.g. the link identification unit (523) may identify locations of the selected links in the webpage 602. Accordingly, the link identification unit (523) may transmit a request for the locations of the selected links to the browser controlling the browser window. Upon receiving the request, the browser may identify location of the selected links based on a render tree created for the webpage 602, as known in the art.

For the sake of brevity and for the ease of understanding, the process is briefly described here. Accordingly, a rendering engine of the browser parses a data file corresponding to the webpage 602, such as an HTML file or XML file, and creates a parse tree or a data object model (DOM) tree. The DOM tree provides a hierarchy of webpage elements of the webpage 602. Thereafter, the rendering engine parses styles attributes and combines with the DOM tree to create a render tree. The render tree orders visual components of the webpage elements such as height, width, and colour in a hierarchy according to which they are to be displayed in the browser. Upon creation of the render tree, the rendering engine recursively traverses through the nodes in the render tree to determine a location of the webpage elements, including the selected links in the webpage 602. As such, the rendering engine starts at a top left position (0,0) of the browser window and maps the webpage elements to corresponding coordinates on the browser window. Upon mapping, the rendering engine transmits the location of the selected links to the link identification unit (523).

As illustrated in FIG. 6F, upon determining the location of the selected links, the processor(520), e.g. the tagging unit (524) may capture a screenshot of the webpage 602 and tag the selected links at relative positions on the screenshot, generating a screenshot 608. As would be understood, the tagging of links includes associating information corresponding to the selected links with the screenshot. The information for a link may include a name of the link, brief description of the link, brief description of content, and position of the link In the FIG. 6F, reference numerals 609-1 and 609-2 point to the tagged links 603-2 and 603-4, respectively. Further, the information is editable in the screenshot. As such, the tagging unit (524) may further provide various options to the user to modify the information. Examples of such options include editing, deleting, and renaming the information.

Further, the processor(520), e.g. the tagging unit (524) may tag the selected links in the screenshot in a manner as known in the art. In one example, the tagging unit (524) may tag the selected links based on face-tagging techniques presently used for tagging a face included in an image. In one example, upon creation of the screenshot 608, the tagging unit (524) may tag the selected links and provide a notification to the user indicating the creation of the screenshot 608.

In one aspect of the present disclosure, the user may preselect the area to be captured. In one example, the user may preselect an option to capture the visible area of a webpage. In such an example, the processor(520), e.g. the tagging unit (524) always captures a screenshot of the visible area of the webpage upon receiving a request to capture a screenshot from the user.

In another aspect of the present disclosure, the user may preselect an option to tag all links included in the webpage 602. As such, the processor(520), e.g. the tagging unit (524) always tags all the links included in the webpage 602 upon receiving a request to capture a screenshot from the user. It would be understood that when the screenshot is captured for a selected area of the webpage 602, then the tagging unit (524) always tags all the links included in the selected area of webpage.

In one another aspect of the present disclosure, the user may preselect an option for tagging links included in the webpage 602 based on user profile. A user profile includes data indicative of historical tagging and attributes related to the user. As such, upon receiving a request to capture a screenshot from a user, the processor(520), e.g. the tagging unit (524) may tag links included in the webpage 602 based on a user profile of the user. Further, the link identification unit (523) may provide a recommendation of links included in the webpage 602 that match the user profile.

In yet another aspect of the present disclosure, the user may preselect the area to be captured along with links to be tagged. In one example, the user may preselect options to capture the visible area of the webpage and to tag all links included in the visible area of the webpage. In another example, the user may preselect options to capture the visible area of the webpage and to tag select links included in the visible area of the webpage.

Furthermore, the processor(520), e.g. the tagging unit (524) may create metadata indicative of a mapping of the tagged links and the corresponding relative positions on the screenshot 608. Further, in one aspect of the present disclosure, the tagging unit (524) may create a mapping of all links included in the selected area of the webpage 602 and provide identification for each of the links to indicate the links tagged in the screenshot 608. In another aspect, the metadata only includes the selected links tagged in the screenshot 608.

In one example, the metadata may be created in form of the table 1 below.

TABLE 1
Webpage Title

| | | Relative Position | |
|---|---|---|---|
| Title of Links | URL | (Coordinates) | Tagged |
| Link 1 (603-1) | www.some-website.com | (x1, y1), (x2, y2) | No |
| Sub Link 2 | www.some-link1.com | (x3, y3), (x4, y4) | Yes |
| (603-2) | | | |
| Sub Link 3 | www.some-link2.com | (x6, y6), (x6, y6) | No |
| (603-3) | | | |
| Sub Link 4 | www.some-link2.com | (x7, y7), (x8, y9) | Yes |
| (603-4) | | | |

In the above example table, the tagging unit (524) stores the mapping of all the links 603-1, 603-2, 603-3, and 603-4 present in the webpage corresponding to their relative positions on the screenshot 608. Further, the user has selected only links 603-1 and 603-3. Therefore, the tagging unit (524) saves an indication of tagged against the selected links 603-2 and 603-4.

Further, the metadata may include geographical location information about the selected links. In one example, the processor(520), e.g. the tagging unit (524) may provide an option to the user to include the geographical location information in the metadata. In another example, the tagging unit (524) may automatically include the geographical location information in the metadata. Subsequently, upon creation of the screenshot 608 and association of the metadata with the screenshot 608, the tagging unit (524) may save the screenshot 608 as a data file in a memory of the electronic device 601. Examples of the data file may include an image, a word document, and a PDF file.

Furthermore, as illustrated in FIG. 6G, the processor(520), e.g. the tagging unit (524) may provide a third option menu 609 which enables the user to associate the metadata with the screenshot 608. Accordingly, in one aspect of the present disclosure, the metadata may be embedded within the screenshot 608. In an example, the screenshot may be saved as a data file such as an image or PDF and the metadata may be saved as ‘properties’ of the data file. In such an aspect, the tagging unit (524) saves the screenshot 608 along with the embedded metadata in a memory of the electronic device 601. Further, in such an aspect, the metadata may be in a format such as, for example, Exchangeable Image File Format (EXIF), International Press Telecommunication Council (IPTC), and Extensible Metadata Platform (XMP).

In another aspect of the present disclosure, the metadata may be saved in a separate file distinct from the screenshot 608. In an example, the screenshot 608 may be saved as a data file such as an image or PDF and the metadata may be saved as a separate data file such as a text file. In such an aspect, the processor(520), e.g. the tagging unit (524) saves the screenshot 608 and the separate file indicative of the metadata in a memory of the electronic device 601. Thus, when the user shares the screenshot across multiple electronic devices through various applications, the metadata may be shared along with the screenshot 608. This enables a electronic device receiving the screenshot 608 to access the separate file indicative of the metadata along with the screenshot 608.

In another aspect of the present disclosure, the metadata may be saved in a separate file, distinct from the screenshot 608, over a network. In an example, the screenshot 608 may be saved as a data file such as an image or PDF and the metadata may be saved as a separate data file such as a text file. In such an aspect, the processor(520), e.g. the tagging unit (524) may save the screenshot 608 in a memory of the electronic device 601 and the separate file indicative of the metadata in a database (not shown in the figure) such as a cloud based database or remote network database. Thus, when the user shares the screenshot 608 across multiple electronic devices through various applications, the screenshot 608 is shared, but without also sharing the metadata. An electronic device receiving the screenshot 608 may access the separate file indicative of the metadata from the network when accessing the screenshot 608. In an example, the electronic device receiving the screenshot 608 provides authentication information to access the separate file indicative of the metadata from the network.

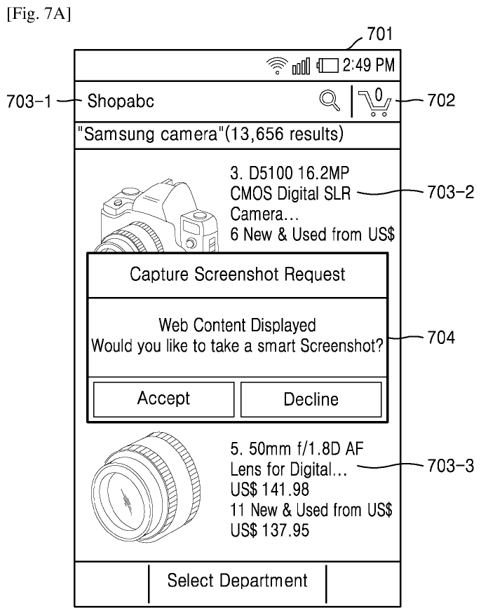

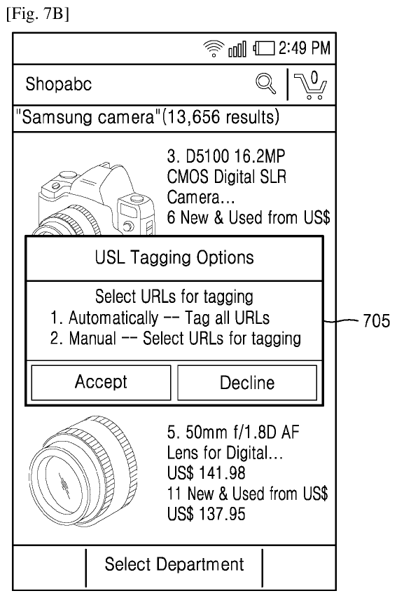

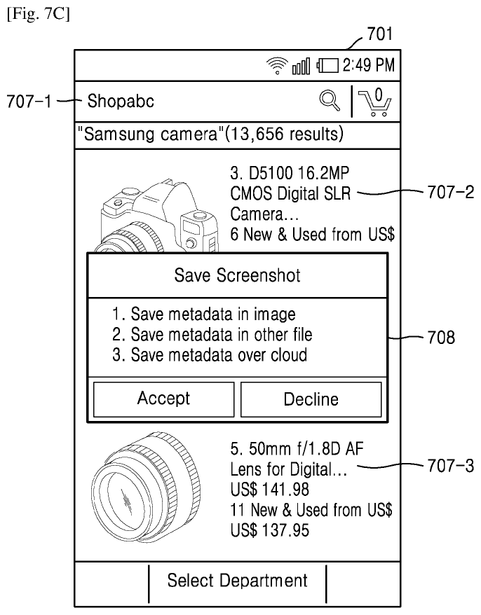

Referring to FIG. 7A-7C, a process of tagging links included in a screenshot of a page of an application is illustrated in accordance with another example embodiment of the present disclosure.

Accordingly, FIG. 7A illustrates an example electronic device, e.g, mobile device 701 displaying a page of application 702 via a display of the mobile device 701. Examples of such a mobile device include a smart phone, a wearable device, and a personal digital assistant (PDA).

Further, the application may be an application installed in the mobile device 701. Examples of the application include an e-commerce application and a location-based service (LBS) listing application. Additionally, in one example, the application may be a native application downloaded from an application stored and installed on the mobile device 701. In another example, the application may be a mobile web application accessed over a browser installed on the mobile device 701. In yet another example, the application may be a hybrid application having features of both the native application and the mobile web application.

Furthermore, the page of the application 702 includes various page elements such as videos, text, static images, animated images, hyperlinks or navigational elements to other portions of a webpage, and data files linked through hyperlinks. The page 702 may further include one or more links, as described in reference to FIG. 7A. For the ease of understanding, the page 702 includes plurality of links 703-1, 703-2, and 703-3 such that link 703-1 corresponds to the page 702 and links 703-2 and 703-3 corresponds to other pages of the same application, pages of a different application, or a mobile based webpage.

In accordance with an example embodiment of the present disclosure, and as described in reference to FIG. 7A, a feature of tagging the plurality of links 703-1, 703-2, and 703-3 included in a screenshot of the page 702 is provided. The feature may be provided in multiple ways such as, for example, an add-on feature provided by a screen capture module of the application, a specific feature provided by a screen capture application installed on the mobile device 701, and an integrated feature of an operating system of the mobile device 701.

As illustrated in FIG. 7A and referring to FIG. 6A, upon receiving a request to capture a screenshot of the page 702 from the user, the processor(520), e.g. the link identification unit (523) may identify whether any links are included in the page 702. Accordingly, the link identification unit (523) may transmit a request to a content rendering module associated with the application. The content rendering module may include information about the various page elements available on each page of the application along with corresponding locations of the webpage elements on the rendered page. In an example, the content rendering module may include a mapping of the various page elements with corresponding locations. Based on the request, the content rendering module may provide information to the link identification unit (523) indicating whether links are included in the page 702, along with a list of links.

Based on the list of links included in the page 702, the processor(520), e.g. the link identification unit (523) may provide a notification 704 to the user indicating links included in the page 702 and an option of tagging the links in a screenshot of the page 702. On the contrary, if no links are include in the page 702, the link identification unit (523) may enable capturing of a screenshot of the page 702 in a conventional manner as known in the art.

As illustrated in FIG. 7B and referring to FIG. 6C, upon receiving a user input selecting the option to tag the included links, the link identification unit (523) may provide a first option notification 705 on the page 702 enabling the user to select the links included in the page 702. As such, the first option notification 705 enables the user to either select all of the links available in the page 702 or select one or more links available in the page 702. In an example, a user-interface providing the first option notification 705 may be overlaid on the page 702, and the user may select the links via the user-interface. As described earlier, in one aspect of the present disclosure, the user may preselect an option for tagging of all links included in the page 702.

Further, as described in reference to FIG. 6D, the processor(520), e.g. the link identification unit (523) may provide a menu listing the plurality of links 703-1, 703-2, 703-3, and 703-4 and an option to select one or more of the plurality of links 703-1, 703-2, 703-3, and 703-4. Upon receiving the selection of the links in the page 702, the link identification unit (523) may identify locations of the selected links in the page 702. Accordingly, the link identification unit (523) may transmit a request for the location of the selected links to the content rendering module associated with the application. Upon receiving the request, the content rendering module may identify the locations of the selected links and transmit the locations to the link identification unit (523). In an example, the content rendering module may identify the locations from the mapping.

As illustrated in FIG. 7C, upon determining the location of the selected links, the processor(520), e.g. the tagging unit (524) may capture a screenshot of the page 702 and tag the selected links at a relative position on the screenshot, generating a screenshot 706. As would be understood, the tagging of links includes associating information corresponding to the selected links with the screenshot 706. The information can include, for each link, a name of the link, a brief description of the link, a brief description of content corresponding to the link, and geographical information associated with the link In the FIG. 7C, reference numerals 707-1, 707-2, and 707-3 depict the tagged links 703-1, 703-2, and 703-3, respectively. As described earlier, in reference to FIG. 6F, the information in the screenshot is editable. Further, as described earlier, in reference to FIG. 6F, the tagging unit (524) may tag the selected links in the screenshot 706 in a manner as known in the art. Furthermore, the tagging unit (524) may create metadata indicative of a mapping of the tagged links and the corresponding relative positions on the screenshot 706.

As illustrated in FIG. 7C and referring to FIG. 6G, the processor(520), e.g. the tagging unit (524) may provide a second option notification 708, via which the user may select to associate the metadata with the screenshot 706. Accordingly, in one aspect of the present disclosure, the metadata may be embedded within the screenshot 706. In another aspect of the disclosure, the metadata may be saved in a separate file distinct from the screenshot 706. In another aspect of the present disclosure, the metadata may be saved in a separate file distinct from the screenshot 706 over a network. Furthermore, upon creation of the screenshot 706 and association of the metadata with the screenshot 706, the tagging unit (524) may save the screenshot 706 as a data file in a memory of the mobile device 701. Examples of the data file include, for example, an image, a word document, and a PDF file.

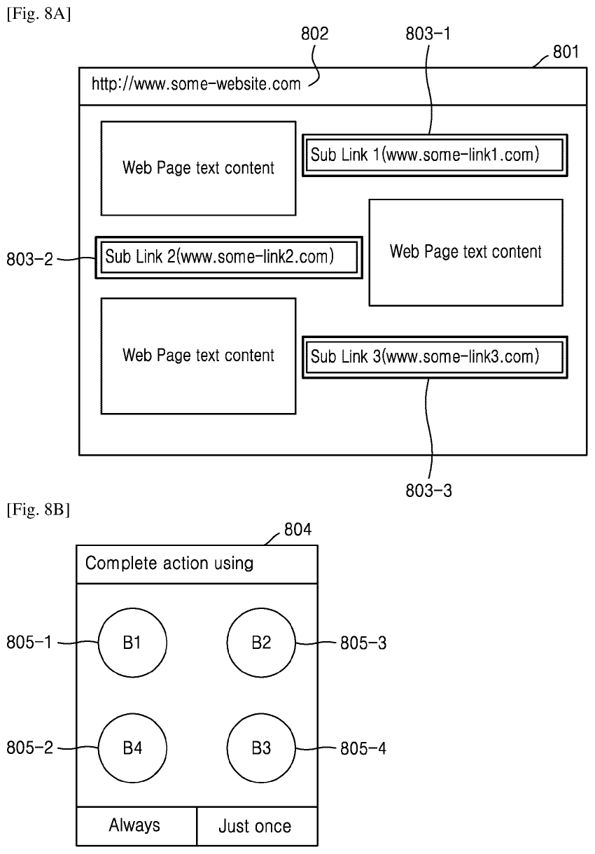

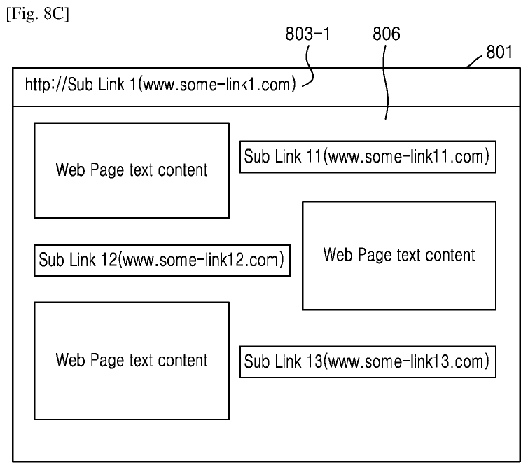

Referring to FIGS. 8A-C and 9, there is illustrated a process for rendering tagged links included in a screenshot, in accordance with various example embodiments of the present disclosure.

Accordingly, FIG. 8A illustrates an example electronic device 801 displaying a screenshot 802. Examples of the electronic device 801 include, for example, a desktop, a notebook PC, a tablet, a laptop, a smart phone, or PDA. In one aspect of the present disclosure, the screenshot 802 may be stored in or accessed from a memory (not shown in the figure) of the electronic device 801. In such an aspect, the electronic device 801 may access an application capable of rendering a screenshot to display the screenshot 802. In one such example, the screenshot 802 may be saved as an image file in the memory and an image rendering application may be accessed to render the image. In another aspect of the present disclosure, the screenshot 802 may be available via a data sharing application installed on the electronic device 801. In such an aspect, the data sharing application is capable of displaying the screenshot 802. In one such example, the screenshot 802 may be made available via a chat application and may be displayed within the chat application.

In accordance with the present disclosure, the input interface 510 of the electronic device 801 may receive a user-input on the screenshot 802 displayed on the electronic device 801. In one aspect of the disclosure, the user-input may correspond to an input while browsing the screenshot 802. Examples of the user-input may include a touch gesture input, a non-touch gesture input, and an input from an input device communicatively coupled to the electronic device 801.

Upon receiving the user-input, the processor(520), e.g. a location determination unit (525) may determine a location of the user-input on the screenshot, as known in the art. Upon determining the location, the link identification unit (523) determines whether a link tagged in the screenshot 802 is located at the determined location of the user-input. Accordingly, the link identification unit (523) obtains metadata associated with the screenshot 802. As described earlier, the metadata is indicative of mapping of one or more links, tagged in the screenshot, with a relative position on the screenshot 802. As described earlier, the links may be uniform resource locators (URLs) pointing to webpages corresponding to a browser or pages rendering web content corresponding to an application. Examples of the application include an e-commerce application and a location-based service (LBS) listing application.

Further, as described earlier, in one aspect of the present disclosure, the metadata may be embedded within the screenshot 802. In such an aspect, the processor(520), e.g. the link identification unit (523) may obtain the metadata from the screenshot 802 and detect a relative position of the tagged link corresponding to the determined location of the user-input based on the metadata.

In another aspect of the present disclosure, the metadata may be saved distinct from the screenshot 802 in a separate file. In one example embodiment, the metadata and the screenshot 802 are available together, e.g., the metadata is embedded in the screenshot. In one example, the metadata and the screenshot 802 may be stored in the memory of the electronic device 801. In another example, the metadata and the screenshot 802 may be accessed via the data sharing application installed on the electronic device 801. In one example embodiment, the metadata may be stored on a remote database such as cloud-based database. Therefore, in such an aspect, the processor(520), e.g. the link identification unit (523) may obtain the file from either the memory or the database. Upon obtaining the file, the link identification unit (523) may detect whether any links correspond to the determined location of the user-input and the metadata, and fetch the links and corresponding relative positions on the screenshot 802 from the file.

Upon determining the links and their corresponding relative positions on the screenshot 802, the processor(520), e.g. the link identification unit (523) may visually indicate the link at the corresponding relative position on the screenshot 802. As illustrated in FIG. 8A, the links tagged in the screenshot 802 may be visually indicated on the screenshot 802. For the ease of understanding, the screenshot 802 includes plurality of links 803-1, 803-2, and 803-3. In one aspect, all links tagged in the screenshot 802 may be visually indicated. In another aspect, only the link available at or near the location of the user-input may be visually indicated.

Further, the processor(520), e.g. the link identification unit (523) may update the relative positions of the links tagged in the screenshot 802 based on a dimension of the screenshot 802 being rendered on the electronic device 801. The dimensions of the screenshot 802 may be determined based a plurality of parameters including screen size of a display unit (not shown in the figure) of the electronic device 801, orientation of the screenshot on the display unit, and a user-input corresponding to a resizing action associated with the screenshot 802. Accordingly, the processor(520), e.g. the link identification unit (523) may determine a resizing factor based on an original dimension of the screenshot 802 and the dimension of the screenshot 802 determined based on the plurality of parameters. Based on the resizing factor, the link identification unit (523) may update the relative position of the links on the screenshot. In one example, the link identification unit (523) may apply the resizing factor to the relative position of the links obtained from the metadata and determine a new relative position of the links corresponding to the dimensions of the screenshot 802.

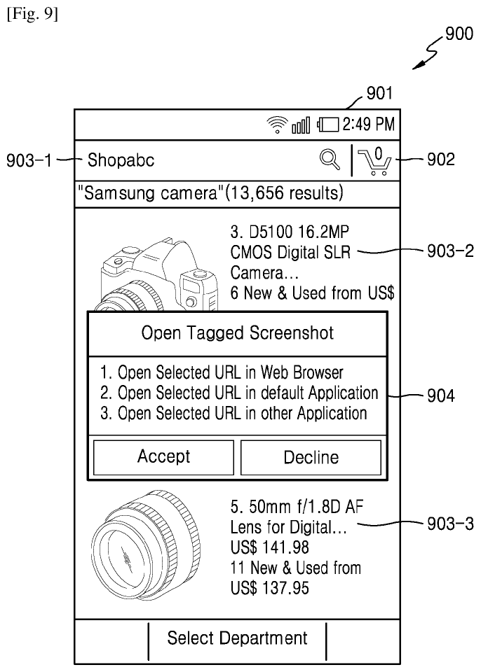

Similarly, FIG. 9 illustrates a mobile device 901 displaying a screenshot 902. Further, as described above, upon receiving a first user-input, the processor(520), e.g. the link identification unit (523) may obtain metadata associated with the screenshot 902 and determine links tagged in the screenshot 902 based on the metadata and location of the user-input. Upon determining the links, the link identification unit (523) may visually indicate the links included in the screenshot 902. For the ease of understanding, the screenshot 902 includes plurality of links 903-1, 903-2, and 903-3.

Further, in one aspect of the present disclosure, the processor(520), e.g. the link identification unit (523) may determine an availability of metadata associated with a screenshot. Upon determining no metadata is available, the link identification unit (523) may provide a corresponding notification.

Upon determining and correspondingly visually indicating the links on the screenshot 802, the processor(520), e.g. the application determination unit (526) may determine sources of the links from the metadata associated with the screenshot. Upon determining the sources of the links, the application determination unit (526) may detect an application corresponding to the links, e.g., an application associated with opening or accessing the links. Upon detecting the application corresponding to the links, the rendering unit (526) may render a page corresponding to the links on the electronic device via the detected application.

In one aspect of the present disclosure, the detected application may be a browser application. Accordingly, in one example embodiment, the processor(520), e.g. the application determination unit (526) may detect a plurality of browser applications available on the electronic device 801. Subsequently, referring to FIG. 8B, the application determination unit (526) may provide a notification 804 on the electronic device 801 indicating the plurality of available browser applications 805-1, 805-2, 805-3, and 805-4. In one example, the notification 804 may be a pop-up message overlaid on the screenshot 802. Further, in one aspect, the notification 804 may be provided for all links tagged in the screenshot 802. In another aspect, the notification 804 may be provided for a link included on the screenshot 802 at or near the location of the first user-input. Accordingly, the input interface (510) may receive user inputs selecting link 803-1 and a browser application 805-1 from the plurality of browser applications 805-1, 805-2, 805-3, and 805-4.

Referring to FIG. 8C, upon receiving the inputs selecting link 803-1 and the browser application 805-1, the processor(520), e.g. the rendering unit (526) may launch a browser window corresponding to the selected browser application 805-1 and render page 806 corresponding to the selected link 803-1. As such, the browser window may render content retrieved from a server and associated with the link 803-1 on the page 806. In one example embodiment, the browser window may be launched in a new browser instance of the browser application. In another example embodiment, the browser window may be launched in a new tab in a prior launched browser instance of the browser application.

Further, in another example embodiment, the processor(520), e.g. the application determination unit (526) may detect a default browser application based on predefined information. The predefined information may be preselected by the user or pre-set by the electronic device 801. Upon detecting the default browser application and receiving a second user-input, which corresponds to accessing the link 803-1, the rendering unit (526) may render the page 806 via the default browser application.

In one aspect of the present disclosure, the detected application may be a mobile-based application. Examples of such mobile-based application include an e-commerce application. Accordingly, in one example embodiment, the processor(520), e.g. the application determination unit (526) may detect availability of the detected mobile-based application. Further, referring to FIG. 9 again, the application determination unit (526) may detect one or more browser applications available on the electronic device 901. The application determination unit (526) may detect a plurality of browser applications available on the electronic device 801. Subsequently, the application determination unit (526) may provide a notification 904 on the electronic device 801 indicating the plurality of browser applications and the detected mobile-based application. In one example, the notification 904 may be a pop-up message overlaid on the screenshot 902. Further, in one aspect, the notification 904 may be provided for all links tagged in the screenshot 902. In another aspect, notification 904 may be provided for the link available at or near the location of the first user-input. Accordingly, the input interface (510) may receive a user input selecting the link 903-1 and an application from the notification.

Upon receiving the inputs selecting link 903-1 and the application, the processor(520), e.g. the rendering unit (526) may launch the selected application and render a page corresponding to the selected link 903-1. Further, in another example embodiment, the rendering unit (526) may launch the detected mobile-based application and render a page corresponding to the selected link 903-1.

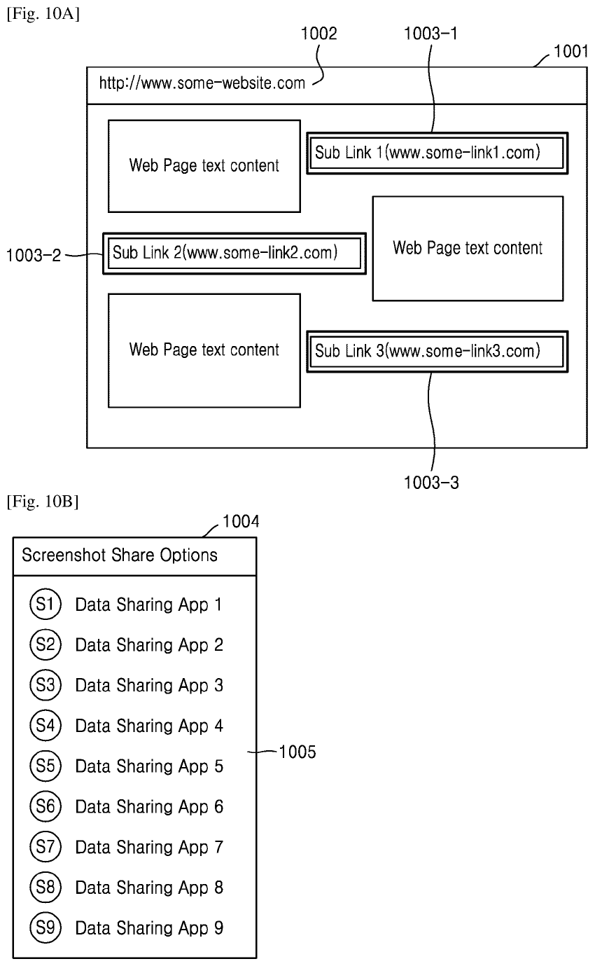

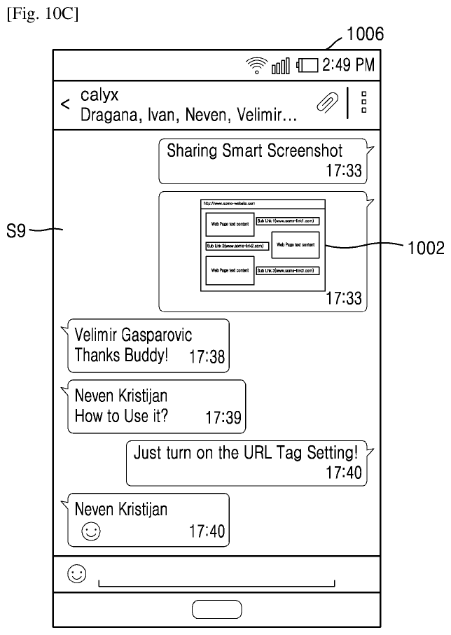

Referring to FIG. 10, an example process (1000) of sharing a screenshot is illustrated in accordance with an example embodiment of the present disclosure. In one aspect of the disclosure, the processor(520), e.g. the tagging unit (524) enables sharing of the screenshot with a plurality of electronic devices via a plurality of data sharing applications available to the user on a electronic device.

Accordingly, FIG. 10(a) illustrates an example first electronic device 1001 displaying a screenshot 1002. Examples of the first electronic device 1001 include a desktop, a notebook PC, a tablet, a laptop, a smart phone, or PDA. The screenshot 1002 includes a plurality of tagged links 1003-1, 1003-2, and 1003-3. The screenshot 1002 may be captured, tagged, and saved using a process as described with reference to FIGS. 6A-6G and 7A-7C. In one aspect of the present disclosure, the screenshot 1002 may include metadata embedded within the screenshot 1002. In another aspect of the present disclosure, the screenshot 1002 and metadata associated with the screenshot 1002 may be stored separately in the first electronic device 1001. In another aspect of the present disclosure, the screenshot 1002 may be stored in the first electronic device 1001 and the metadata associated with the screenshot 1002 may be saved over a network.

Further, the screenshot 1002 may be saved in a memory of the first electronic device 1001 and may be rendered via an application capable of rendering a screenshot. In one example, the screenshot 1002 may be saved as an image file and may be rendered via an image rendering application. In another example, the screenshot 1002 may be saved as a document file and may be rendered via a document rendering application. In yet another example, the screenshot 1002 may be rendered via a screenshot capturing application.

Referring to FIG. 10B, upon viewing the screenshot 1002 on the first electronic device 1001, the tagging unit (524) may provide an option menu 1004 to share the screenshot 1002. Furthermore, the option menu 1004 may be provided via multiple methods such as an add-on feature of the application rendering the screenshot 1002 and specific feature provided by the screen capture application. In an example, a user-interface providing the option menu 1004 may be overlaid on the screenshot 1002, and the user may select a data sharing application via the option menu 1004.

Further, the option menu 1004 enables sharing of the screenshot 1002 via plurality of data sharing applications 1005 available on the electronic device 1001. Examples of the data sharing applications 1005 include, but are not limited to, short-range wireless communication interfaces (such as Bluetooth and Wi-Fi direct), chat applications, social media applications, email applications, media sharing applications, and messaging applications. Further, the plurality of data sharing applications 1005 enable sharing of the screenshot 1002 over plurality of electronic devices, on which the data sharing applications are available. Furthermore, the plurality of data sharing applications 1005 are capable of rendering the screenshot. For sake of brevity and ease of reference, the plurality of data sharing applications 1005 are indicated as S1-S9.

Referring to FIG. 10B, the user selects a data sharing application S9 from the plurality of data sharing applications 1005. Upon receiving the selection, the tagging unit (524) may enable the sharing of the screenshot 1002. Accordingly, the data sharing application S9 may share the screenshot 1002 in a manner as known in the art. In one aspect of the disclosure, the data sharing application S9 may share the screenshot 1002 having embedded metadata. In another aspect of the disclosure, the data sharing application S9 shares the screenshot 1002 and the metadata associated with the screenshot 1002 that are stored separately in the first electronic device 1001. In another aspect of the disclosure, the data sharing application S9 may share the screenshot 1002 stored in the first electronic device 1001, and the metadata associated with the screenshot 1002 may be saved over a network.

As illustrated in FIG. 10C, upon sharing the screenshot 1002, the data sharing application S9 may render the screenshot 1002 on a second electronic device 1006, as described with reference to FIGS. 8A-8C and 9. Examples of the second electronic device 1006 include a desktop, a notebook PC, a tablet, a laptop, a smart phone, or PDA. In an example, in FIG. 10C the data sharing application S9 may be a chat application through which the screenshot 1002 may be shared with a mobile device 1006.

Furthermore, in one aspect of the present disclosure, the tagging unit (524) may provide an option for simultaneously capturing a screenshot of a mobile-based application and sharing the screenshot via a plurality of data sharing applications through the mobile-based application. The data sharing applications include, but are not limited to, social media applications. Further, the same mobile-based application may be used as the data sharing applications. Thus, in such an aspect, the tagging unit (524) enables sharing the screenshot directly from a first electronic device to a second electronic device using the same mobile-based application installed on both devices. This enables direct link access from the mobile-based application installed on a second electronic device.

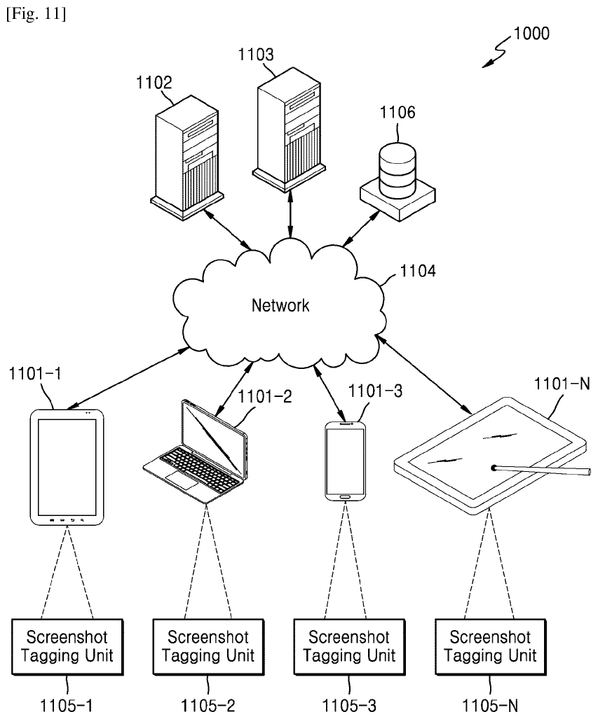

FIG. 11 illustrates an example network environment 1100 implementing a system of tagging a screenshot and rendering the screenshot, as described above, in accordance with various example embodiments of present disclosure.

In accordance with the present disclosure, the network environment 1100 includes a plurality of electronic devices 1101-1, 1101-2, 1101-3, . . . 1101-N (hereinafter, referred to as electronic device 1101 to indicate one electronic device and electronic devices 1101 to indicate two or more electronic devices). Examples of the electronic device 1101 include a desktop, a notebook PC, a tablet, a laptop, a smart phone, or PDA.

The network environment 1100 may further include a web-server 1102 and an application server 1103. The electronic devices 1101 (1101-1, 1101-2, 1101-3, 1101-N) are communicatively coupled with the web-server 1102 and the application server 1103 over a network 1104. Examples of the network 1104 include a wireless network and a wired network. In one example, all the electronic devices 1101 are coupled with both the web-server 1102 and the application server 1103. In another example, some of the electronic devices 1101 are coupled with both the web-server 1102 and the application server 1103, while others of the electronic devices 1101 are coupled with either the web-server 1102 or the application server 1103.

Further, each of the electronic devices 1101 includes a screenshot tagging unit 1105 (1105-1, 1105-2, 1105-3, 1105 -N) for tagging one or more links with a screenshot of a webpage or a page of an application. The screenshot tagging unit 1105 includes the link identification unit (523), the tagging unit (524), the location determination unit (525), the application determination unit (526), and the rendering unit (527), as described with reference to FIG. 5. In one aspect of the present disclosure, the above-mentioned units may be implemented as single screenshot tagging unit 1105. Further, the screenshot tagging unit 1105 may be implemented on the electronic device 1101 in multiple methods such as an add-on feature of a browser available on the electronic device 1101, an add-on feature of a mobile-based application installed on the electronic device 1101, a feature provided by a screen capture application installed on the electronic device 1101, and an integrated feature of an operating system of the electronic device 1101.

In accordance with an example embodiment of the present disclosure, the electronic device 1101 may display a webpage accessed from the web-server 1102 or a page of an application accessed from the application server 1103 via the network 1104. For the sake of brevity, the webpage and the page of the application are hereinafter referred to as a webpage. The webpage may include various webpage elements such as videos, text, static images, animated images, hyperlinks or navigational elements to other portions of a webpage, and data files linked through hyperlinks. The webpage may further include one or more links. The links may be uniform resource locators (URLs) pointing to other webpages. In addition, the videos and images on the webpage may further be associated with links such that clicking on the videos and the images, renders a new webpage associated with the links.

As described in reference to FIGS. 6-11, upon receiving a request to capture a screenshot of the webpage, the screenshot tagging unit 1105 may identify whether any links are included on the webpage. If the screenshot tagging unit 1105 identifies that one or more links are included in the webpage, the screenshot tagging unit 1105 may identify a location of the one or more links on the webpage. Subsequently, the screenshot tagging unit 1105 may capture a screenshot of the webpage and tag the selected links at a relative position on the screenshot corresponding to the identified location to generate a screenshot.

Further, the screenshot tagging unit 1105 may generate metadata indicating a mapping of the tagged links with relative positions on the screenshot. Further, the metadata may indicate the sources of the tagged links. Upon generating the metadata, the screenshot tagging unit 1105 may associate the metadata with the screenshot. In one aspect of the present disclosure, the metadata may be embedded within the screenshot. In such an aspect, the screenshot tagging unit 1105 may save the screenshot along with the embedded metadata in a memory of the electronic device 1101. In another aspect of the present disclosure, the screenshot and metadata associated with the screenshot may be stored separately. In one such aspect, the screenshot and the metadata are stored in separate files in a memory of the electronic device 1101. In another such aspect, the screenshot may be stored in in a memory of the electronic device 1001 and the metadata may be saved in a database 1106 coupled with the electronic device 1101 via the network 1104. In addition, the screenshot tagging unit 1105 enables sharing of the screenshot via a plurality of data sharing applications installed on the electronic devices 1101.

Further, upon receiving a first user-input on the screenshot displayed on the electronic device 1101, the screenshot tagging unit 1105 may determine a location of the first user-input on the screenshot. In an example, the first user-input corresponds to an input while browsing the screenshot. Thereafter, the screenshot tagging unit 1105 may obtain the metadata associated with the screenshot and determine a link tagged in the screenshot based on the metadata and the location of the user-input. Thereafter, the screenshot tagging unit 1105 may determine an application corresponding to the tagged link based on a source of the link available in the metadata. In one aspect of the present disclosure, the application may be a browser application. In another aspect of the disclosure, the application may be a mobile-based application. Upon determining the application, the screenshot tagging unit 1105 may render a page associated with the tagged link in the determined application.

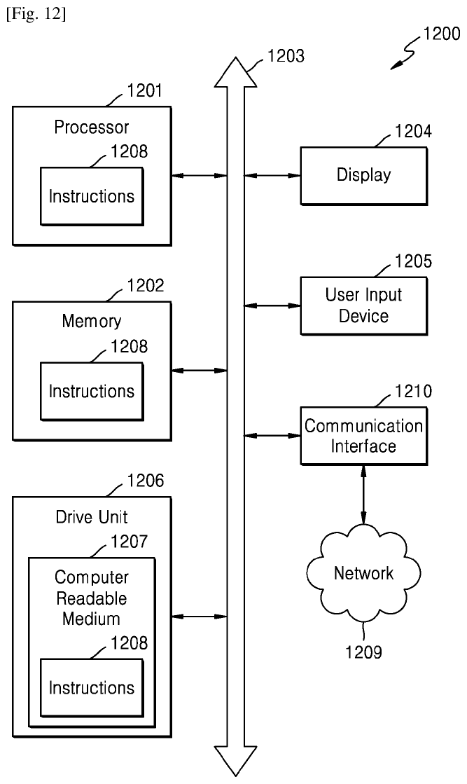

FIG. 12 illustrates a typical hardware configuration of a electronic device 1200, which is representative of a hardware environment for implementing the present disclosure. As would be understood, the electronic devices as described above include the hardware configuration as described below.

In a networked deployment, the electronic device 1200 may operate in the capacity of a server or as a client user computer in a server-client user network environment, or as a peer computer system in a peer-to-peer (or distributed) network environment. The electronic device 1200 can also be implemented as or incorporated into various devices, such as a personal computer (PC), a tablet PC, a personal digital assistant (PDA), a smart phone, a palmtop computer, a laptop, a desktop computer, and a communications device.

The electronic device 1200 may include a processor 1201 e.g., a central processing unit (CPU), a graphics processing unit (GPU), or both. The processor 1201 may be a component in a variety of systems. For example, the processor 1201 may be part of a standard personal computer or a workstation. The processor 1201 may be one or more general processors, digital signal processors, application specific integrated circuits, field programmable gate arrays, servers, networks, digital circuits, analog circuits, combinations thereof, or other now known or later developed devices for analyzing and processing data. The processor 1801 may implement a software program, such as code generated manually (i.e., programmed).

The electronic device 1200 may include a memory 1202 communicating with the processor 1201 via a bus 1203. The memory 1202 may be a main memory, a static memory, or a dynamic memory. The memory 1202 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 1202 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1202 is operable to store instructions executable by the processor 1201. The functions, acts or tasks illustrated in the figures or described may be performed by the programmed processor 1201 executing the instructions stored in the memory 1202. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The electronic device 1200 may further include a display unit 1204, such as a liquid crystal display (LCD), an organic light emitting diode (OLED), a flat panel display, a solid state display, a cathode ray tube (CRT), or other now known or later developed display device for outputting determined information.

Additionally, the electronic device 1200 may include an input device 1205 configured to allow a user to interact with any of the components of electronic device 1200. The input device 1205 may be a number pad, a keyboard, a stylus, an electronic pen, or a cursor control device, such as a mouse, or a joystick, touch screen display, remote control or any other device operative to interact with the electronic device 1200.

The electronic device 1200 may also include a disk or optical drive unit 1206. The drive unit 1206 may include a computer-readable medium 1207 in which one or more sets of instructions 1208, e.g. software, may be embedded. In addition, the instructions 1208 may be separately stored in the processor 1201 and the memory 1202.

The electronic device 1200 may further be in communication with other devices over a network 1209 to communicate voice, video, audio, images, or any other data over the network 1209. Further, the data and/or the instructions 1208 may be transmitted or received over the network 1209 via a communication port or interface 1210 or using the bus 1203. The communication port or interface 1210 may be a part of the processor 1201 or may be a separate component. The communication port 1210 may be created in software or may be a physical connection in hardware. The communication port 1210 may be configured to connect with the network 1209, external media, the display 1204, or any other components in system 1200 or combinations thereof. The connection with the network 1209 may be a physical connection, such as a wired Ethernet connection or may be established wirelessly as discussed later. Likewise, the additional connections with other components of the system 1200 may be physical connections or may be established wirelessly. The network 1209 may alternatively be directly connected to the bus 1203.

The network 1209 may include wired networks, wireless networks, Ethernet AVB networks, or combinations thereof. The wireless network may be a cellular telephone network, an 802.11, 802.16, 802.20, 802.1Q or WiMax network. Further, the network 1209 may be a public network, such as the Internet, a private network, such as an intranet, or combinations thereof, and may utilize a variety of networking protocols now available or later developed including, but is not limited to TCP/IP based networking protocols.

In an alternative example, dedicated hardware example embodiments, such as application specific integrated circuits, programmable logic arrays and other hardware devices, may be constructed to implement various parts of the electronic device 1200.

Applications that may include the systems can broadly include a variety of electronic and computer systems. One or more examples described may implement functions using two or more specific interconnected hardware modules or devices with related control and data signals that may be communicated between and through the modules, or as portions of an application-specific integrated circuit. Accordingly, the present system encompasses software, firmware, and hardware example embodiments.

The electronic device 1200 may be implemented by software programs executable by the processor 1201. Further, in a non-limited example, embodiments can include distributed processing, component/object distributed processing, and parallel processing. Alternatively, virtual computer system processing may be constructed to implement various parts of the system.

The electronic device 1200 is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements. Elements from one example embodiment may be added to another example embodiment. For example, orders of processes described herein may be changed and are not limited to the manner described herein. Moreover, the actions of any flow diagram need not be implemented in the order shown; nor do all of the acts necessarily need to be performed. In addition, those acts that are not dependent on other acts may be performed in parallel with the other acts. The scope of example embodiments is by no means limited by these specific examples. Numerous variations, whether explicitly given in the specification or not, such as differences in structure, dimension, and use of material, are possible. The scope of example embodiments is at least as broad as given by the following claims.

While certain present preferred example embodiments of the present disclosure have been illustrated and described herein, it is to be understood that the present disclosure is not limited thereto. Clearly, the present disclosure may be otherwise variously embodied and practiced within the scope of the following claims.

1. A method of tagging links included in a screenshot of a webpage, the method comprising;
identifying one or more links included in a first webpage and a location of the one or more links in the first webpage, the first webpage being rendered on a electronic device; and
tagging the one or more links at a position on a screenshot of the first webpage, the position corresponding to the identified location, and accessing a tagged link included in the screenshot includes rendering a second webpage associated with the tagged link.

2. The method as claimed in claim 1, wherein the identifying and the tagging are based on a request to capture the screenshot of the first webpage, the request being received by the electronic device from a user.

3. The method as claimed in claim 2, wherein the request to capture the screenshot is received via one of: a browser window, the electronic device, and a screen capture application installed on the electronic device.

4. The method as claimed in claim 1, wherein the tagging further comprises:
generating metadata indicative of a mapping of the tagged one or more links and the position on the screenshot; and
associating the metadata with the screenshot.

5. The method as claimed in claim 2 further comprises:
receiving an input selecting an area of the first webpage to be captured in the screenshot of the first webpage, wherein the one or more links are included within the selected area.

6. An electronic device for tagging links included in a screenshot of a webpage, the electronic device comprising;
a display configured to: display a first webpage and a second webpage; and
at least one processor configured to:
identify one or more links included in the first webpage; identify a location of the one or more links in the first webpage; and
tag the one or more links at a position on a screenshot of the first webpage, the position corresponding to the identified location, access a tagged link on the screenshot includes rendering the second webpage associated with the tagged link

7. The electronic device as claimed in claim 6, wherein the at least one processor configured to identify and tag based on a request to capture the screenshot of the first webpage, the request being received by the electronic device from a user.

8. The electronic device as claimed in claim 7, wherein the request to capture the screenshot is received via one of: a first browser window, the electronic device, and a screen capture application installed on the electronic device.

9. The electronic device as claimed in claim 6, wherein the at least one processor configured to generating metadata indicative of a mapping of the tagged one or more links and the position on the screenshot; and
associate the metadata with the screenshot.

10. A method comprising:
receiving a user-input on a screenshot being rendered on a electronic device;
determining a location of the user-input on the screenshot;
determining whether a tagged link included in the screenshot is located at the determined location; and
rendering a webpage associated with the tagged link in a browser window on the electronic device in response to receiving a request to access the tagged link

11. The method as claimed in claim 10, further comprising obtaining metadata associated with the screenshot, the metadata including a mapping of one or more tagged links included in the screenshot and a position of the one or more tagged links on the screenshot.

12. The method as claimed in claim 11, wherein the metadata is embedded within the screenshot, and the determination of whether the tagged link included in the screenshot is located at the determined location further comprises:
detecting a position of the tagged link, and determining whether the detected position of the tagged link corresponds to the location of the user-input, based on the metadata; and
visually indicating the tagged link at the detected position on the screenshot.

13. The method as claimed in claim 11, further comprising:
determining dimensions of the screenshot; and
updating the position of the one or more tagged links on the screenshot based on the determined dimensions.

14. The method as claimed in claim 13, wherein the dimensions of the screenshot are determined based on one or more of: screen size of a display unit of the electronic device, orientation of the screenshot on the display unit, and a user-input corresponding to a resizing action associated with the screenshot.

15. A computer readable medium comprising instructions executable by a computer to perform the method of claim 1.
